(19) United States
(12) Patent Application Publication
(10) Pub. No.: US 2018/0268776 A1
(43) Pub. Date: Sep. 20, 2018

(54) SMART APPARATUS AND OPERATING SYSTEM FOR THE SAME

(71) Applicant: ALL SPACETIME DIMENSION ELECTRICS LABORATORY CO., LTD., TAICHUNG CITY (TW)

(72) Inventors: Chia-Yu WANG, TAICHUNG CITY (TW); Dai-Shin HO, TAICHUNG CITY (TW); Chiang-Wen LAI, TAICHUNG CITY (TW)

(21) Appl. No.: 15/461,134

(22) Filed: Mar. 16, 2017

(51) Int. Cl. G09G 5/00; G08C 17/02; H05B 37/02; G09G 5/10

(52) U.S. Cl. CPC G09G 5/006; G08C 17/02; H05B 37/0272; G09G 2370/022; G09G 2330/02; G09G 2370/16; G09G 5/10

(57) ABSTRACT

A smart apparatus includes an action figure, a base, a control unit, a display device, a colored light emitting module, and a power supply module. The first wireless transmission module of the control unit wirelessly receives an execution signal and sends it to the first microprocessor to generate a first power signal, a second power signal or a display signal. The power control module controls the display device and the colored light emitting module according to strength levels of the first and second power signals, respectively, to brighten, darken or switch between multiple colors. The first microprocessor sends a data to the display device according to the display signal to display the data. A smart apparatus operating system which includes a smart electronic device is further provided.

### BACKGROUND OF THE INVENTION

### Field of the Invention

The present invention relates to smart apparatuses and, more particularly, to a smart apparatus and a smart apparatus operating system, characterized in that the smart apparatus is equipped with an action figure and operated according to a wireless communication protocol to enable two-way communication between the action figure and a user.

### Description of the Prior Art

To impress religious believers and followers during temple festivals and rituals as well as religious events, action figures which not only bless people with safety and well-being but also serve decorative purposes develop. For example, Taiwan patent M399938, entitled Peaceful Action Figure Peace Lantern, discloses: a peaceful action figure peace lantern whose body (denoted by reference numeral 1) is provided with a receiving chamber (denoted by reference numeral 10) and a lamp (denoted by reference numeral 2); the lamp (denoted by reference numeral 2) is disposed in the receiving chamber (denoted by reference numeral 10); the lamp (denoted by reference numeral 2) comes with a first casing (denoted by reference numeral 20), a second casing (denoted by reference numeral 21), and a power component (denoted by reference numeral 26); the first casing (denoted by reference numeral 20) and the second casing (denoted by reference numeral 21) are fastened to each other and thus coupled together; and the power component (denoted by reference numeral 26) supplies power to a display lamp (denoted by reference numeral 270) of a circuit board (denoted by reference numeral 27) to light the peaceful action figure peace lantern or turn off the display lamp (denoted by reference numeral 270). Hence, the peaceful action figure peace lantern not only blesses people with safety and well-being but also serves decorative purposes.

The display lamp (denoted by reference numeral 270) of the lamp (denoted by reference numeral 2) mounted on the body (denoted by reference numeral 1) of the conventional peaceful action figure peace lantern brightens or darkens to visually comfort users to some extent. However, users cannot add or modify (hereinafter collectively referred to as “editing”) blessing-related graphics/text on the conventional peaceful action figure peace lantern with a view to attaining physical, mental and spiritual relaxation.

Accordingly, it is imperative to provide a blessing-oriented action figure which operates audiovisually, serves decorative purposes, blesses people with safety and well-being, and is editable digitally according to a wireless communication transmission protocol.

### SUMMARY OF THE INVENTION

In view of the aforesaid drawbacks of the prior art, it is an objective of the present invention to provide a smart apparatus which a user sends a signal or data to according to a wireless communication transmission protocol, and the smart apparatus operates audiovisually, serves decorative purposes, blesses people with safety and well-being, is editable digitally, smartly, and is capable of signal/data transmission and communication.

In order to achieve the above and other objectives, the present invention provides a smart apparatus, comprising an action figure, a base, a control unit, a display device, a colored light emitting module, and a power supply module.

The action figure having an engaging portion.

The base having a receiving space and a constraint channel concavely formed on a surface of a top of the base so that the engaging portion of the action figure is engaged with and fixed to the constraint channel of the base.

The control unit disposed in the receiving space of the base and having a first wireless transmission module, a first microprocessor, a memory module, and a power control module, with the first microprocessor electrically connected to the first wireless transmission module, the memory module, and the power control module, respectively.

The display device mounted on the base and electrically connected to the first microprocessor and the power control module of the control unit, respectively.

The colored light emitting module disposed in the receiving space of the base and electrically connected to the power control module of the control unit.

The power supply module disposed in the receiving space of the base and respectively electrically connected to the control unit, the display device, and the colored light emitting module to supply power to the control unit, the display device, and the colored light emitting module.

The first wireless transmission module wirelessly receives an execution signal emitted from an external signal source and sends the execution signal to the first microprocessor, and the first microprocessor generates a first power signal, a second power signal, or a display signal according to the execution signal. The power control module controls the display device to brighten or darken according to a strength level of the first power signal and controls the colored light emitting module to brighten, darken or switch between multiple colors according to a strength level of the second power signal, whereas the first microprocessor sends, according to the display signal, a data pre-stored in the memory module to the display device for display and sends a confirmation signal to the external signal source wirelessly through the first wireless transmission module.

The present invention further provides a smart apparatus operating system, comprising the smart apparatus and a smart electronic device. The smart electronic device has an application and a second wireless transmission module. The application is executable by the smart electronic device. The second wireless transmission module is controlled by the smart electronic device. The second wireless transmission module of the smart electronic device is wirelessly, electrically connected to the first wireless transmission module of the control unit of the smart apparatus.

The application is executed by the smart electronic device to generate the execution signal, and the second wireless transmission module sends the execution signal to the first wireless transmission module of the control unit of the smart apparatus and then to the first microprocessor according to a communication protocol. The first microprocessor generates the first power signal, the second power signal, or the display signal according to the execution signal. The first microprocessor wirelessly transmits the confirmation signal to the second wireless transmission module of the smart electronic device through the first wireless transmission module, and then the confirmation signal is displayed by the application.

### BRIEF DESCRIPTION OF THE DRAWINGS

FIG. 1 is a perspective view of a smart apparatus according to the first preferred embodiment of the present invention;

FIG. 2 is a partial exploded view of the smart apparatus according to the first preferred embodiment of the present invention;

FIG. 3 is a perspective view of the smart apparatus according to the second preferred embodiment of the present invention;

FIG. 4 is a partial exploded view of the smart apparatus according to the second preferred embodiment of the present invention;

FIG. 5 is the first block diagram of the present invention;

FIG. 6 is the second block diagram of the present invention; and

FIG. 7 is the third block diagram of the present invention.

### DETAILED DESCRIPTION OF THE EMBODIMENT OF THE INVENTION

Structural features and anticipated advantages of the present invention are illustrated by embodiments, depicted with accompanying drawings, and described below. Identical reference numerals used in the embodiments and drawings indicate identical or similar elements, components, objects, structures, systems, frameworks, devices, process flows, methods, or steps.

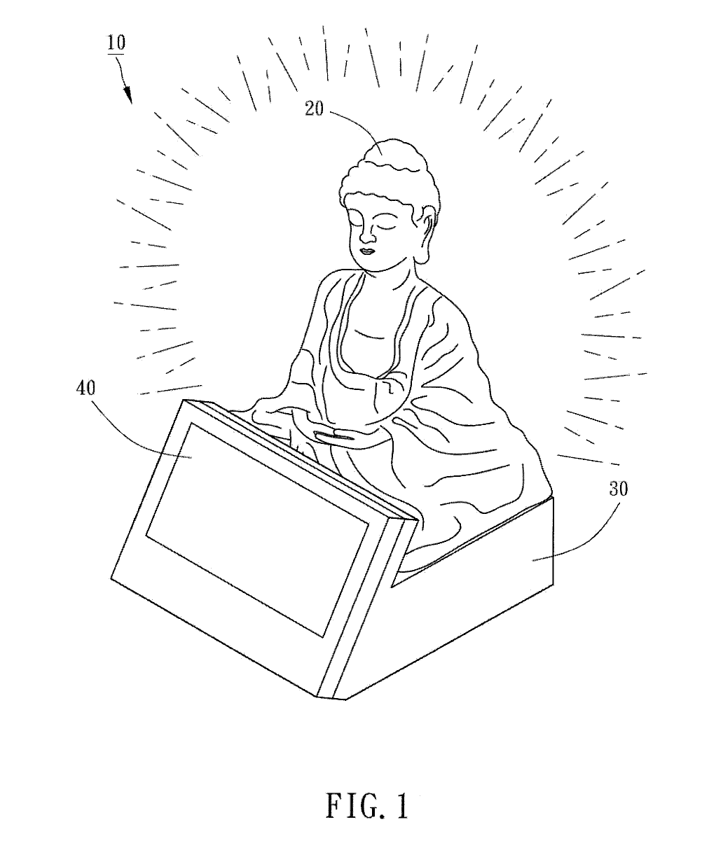

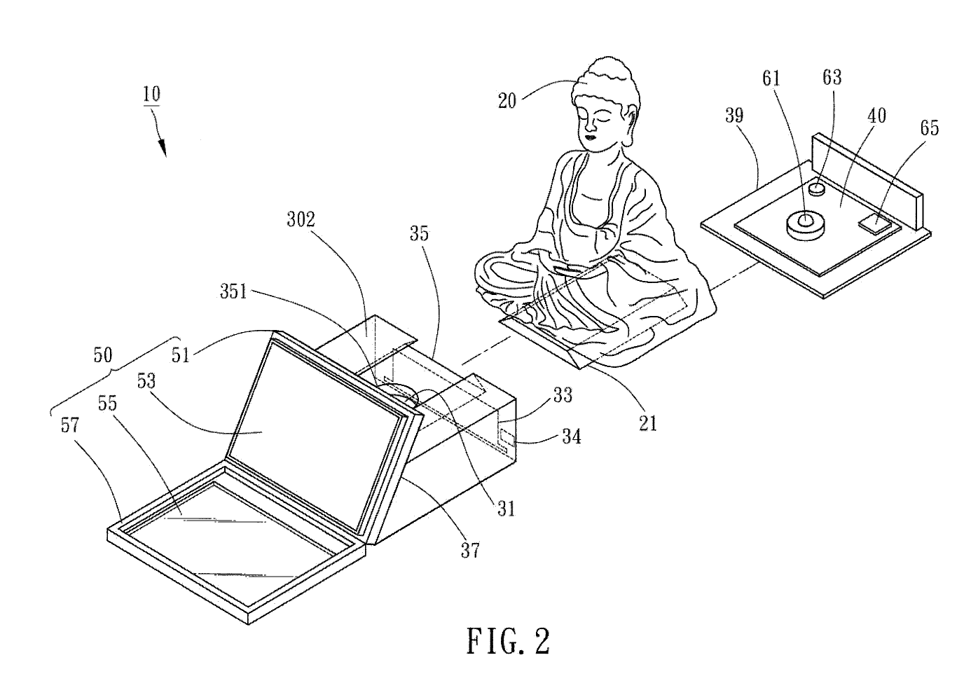

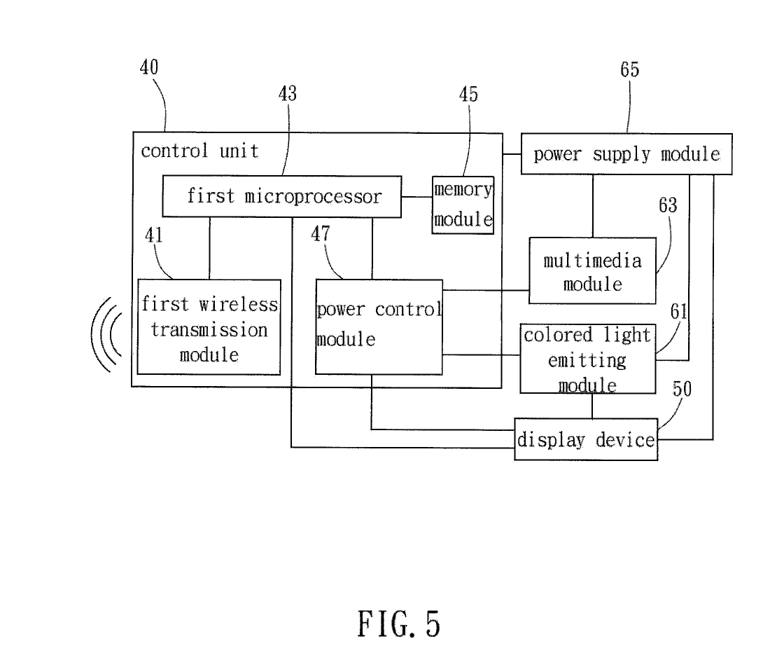

Referring to FIGS. 1, 2, and 5, the present invention provides a smart apparatus 10 which comprises an action FIG. 20, a base 30, a control unit 40, a display device 50, a colored light emitting module 61, a multimedia module 63, and a power supply module 65.

The action FIG. 20 has an engaging portion 21. In this embodiment, the engaging portion 21 of the action FIG. 20 extends outward away from the bottom thereof to form a wedge-shaped protruding wall. The action FIG. 20 is intended for use in temple festivals and rituals, ceremonies, religious events, and special offerings, for example, by being a human action figure, an animal action figure, an indicative action figure, or a custom-made innovative action figure.

The base 30 has a receiving space 31, a opening 33 is in communication with the receiving space 31, a constraint channel 35, a mounting portion 37, and a holder 39. The constraint channel 35 is concavely formed on the surface of a top 302 of the base 30 and corresponds in shape to the wedge-shaped protruding wall of the engaging portion 21 of the action FIG. 20 so that the engaging portion 21 of the action FIG. 20 is engaged with and thus fixed to the constraint channel 35 of the base 30. A through hole 351 is penetratingly disposed at the bottom of the constraint channel 35. The through hole 351 is in communication with the receiving space 31. In this embodiment, the axial direction of the opening 33 of the base 30 crosses the axial direction of the through hole 351 of the constraint channel 35. Preferably, an included angle of 90 degrees or so is formed between the two axial directions. The mounting portion 37 is disposed on an end surface of the base 30 and opposite the opening 33. The holder 39 is snugly embedded into the receiving space 31 through the opening 33 of the base 30.

The control unit 40 is disposed in the receiving space 31 of the base 30. Preferably, the control unit 40 is placed on the holder 39 and thereby embedded into the receiving space 31 of the base 30. The control unit 40 has a first wireless transmission module 41, a first microprocessor 43, a memory module 45, and a power control module 47. The first microprocessor 43 is electrically connected to the first wireless transmission module 41, the memory module 45, and the power control module 47, respectively. In this embodiment, the first wireless transmission module 41 effectuates data or signal transmission according to a wireless transmission communication protocol, such as Wi-Fi, wireless radio frequency (RF or sub-one GHz RF) communication transmission protocol, ZigBee, Bluetooth communication transmission protocol (including but not limited to Bluetooth h2.x+EDR, Bluetooth h3.0+HS, Bluetooth 4.x, Bluetooth Low Energy), or NFC (near field communication). The power control module 47 comprises an AC/DC converter, a DC/DC converter, and an AC/DC power management control (AC/DC PMC). However, the aforesaid technical features are not restrictive of this embodiment of the present invention.

The display device 50 is mounted on the base 30. Preferably, the display device 50 is mounted on the mounting portion 37 of the base 30. The included angle formed between the display device 50 and the axial direction of the opening 33 of the base 30 preferably ranges from 20 degrees to 80 degrees. The display device 50 is electrically connected to the first microprocessor 43 and the power control module 47 of the control unit 40, respectively. In this embodiment, the display device 50 comprises a casing 51, a display 53, a dust-proof cover 55, and a top cover 57. The display 53 is disposed in the casing 51. The dust-proof cover 55 is a light penetrable component and covers the display 53 to prevent dust from falling onto the display 53 to the detriment of the quality of data display. One end of the top cover 57 is pivotally connected to the casing 51. After being pivotally rotated by a predetermined angle, the top cover 57 covers the casing 51, the display 53, and the dust-proof cover 55, thereby allowing a user to mount the display device 50 and other related components on the base 30 easily. The display 53 is exemplified by an electronic paper (e-Paper) module, an organic light-emitting diode (OLED) module, or a thin film transistor liquid crystal display (TFT-LCD) module. However, the aforesaid technical features are not restrictive of this embodiment of the present invention.

The colored light emitting module 61 is disposed in the receiving space 31 of the base 30 and exposed from the through hole 351 of the constraint channel 35 of the base 30. Preferably, the colored light emitting module 61 is placed on the holder 39 and thereby embedded into the receiving space 31 of the base 30. The colored light emitting module 61 is electrically connected to the power control module 47 of the control unit 40. In this embodiment, the colored light emitting module 61 is exemplified by a conventional multi-color light-emitting diode (multi-color LED) for use in building lighting, stage lighting, indoor decoration, vegetation lamps, or the other color-mixing illumination fields. However, the aforesaid technical features are not restrictive of this embodiment of the present invention.

The multimedia module 63 is disposed at the base 30. Preferably, the multimedia module 63 is placed on the holder 39 and thereby embedded into the receiving space 31 of the base 30. The multimedia module 63 is electrically connected to the power control module 47 of the control unit 40. In this embodiment, the multimedia module 63 is exemplified by a conventional speaker capable of recording or playing or a conventional lens capable of taking pictures. The multimedia module 63 is electrically controlled by the power control module 47.

The power supply module 65 is disposed in the receiving space 31 of the base 30. Preferably, the power supply module 65 is placed on the holder 39 and thereby embedded into the receiving space 31 of the base 30. The power supply module 65 is electrically connected to the control unit 40, the display device 50, the colored light emitting module 61, and the multimedia module 63, respectively. The power supply module 65 supplies power to the control unit 40, the display device 50, the colored light emitting module 61, and the multimedia module 63, respectively. In this embodiment, the power supply module 65 comprises an external power (not shown, for example, a conventional AC voltage source AC-110V or AC-220V) and a built-in battery power (not shown), each of which is electrically connected to the control unit 40, the display device 50, the colored light emitting module 61, and the multimedia module 63, respectively. The external power or the built-in battery power is selected by the user as needed to supply power to the control unit 40, the display device 50, the colored light emitting module 61, and the multimedia module 63. Preferably, a power cable (not shown) passes through a power jack 34 of the base 30 and thus is electrically connected to the external power of the power supply module 65.

The essential structures and technical features of the first preferred embodiment of the present invention are described above. The essential structures and technical features of the second preferred embodiment of the present invention are described above.

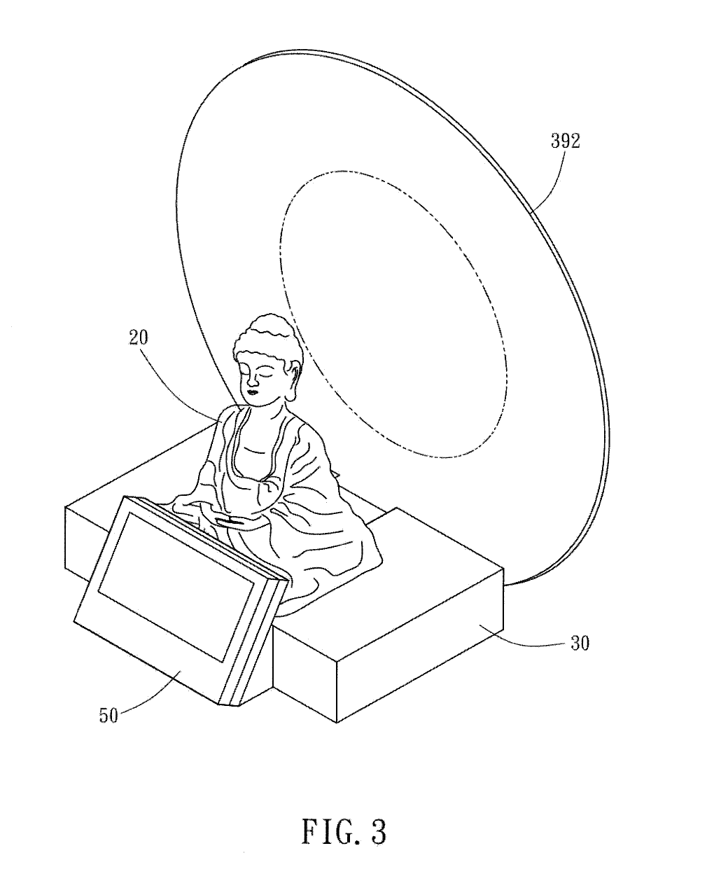

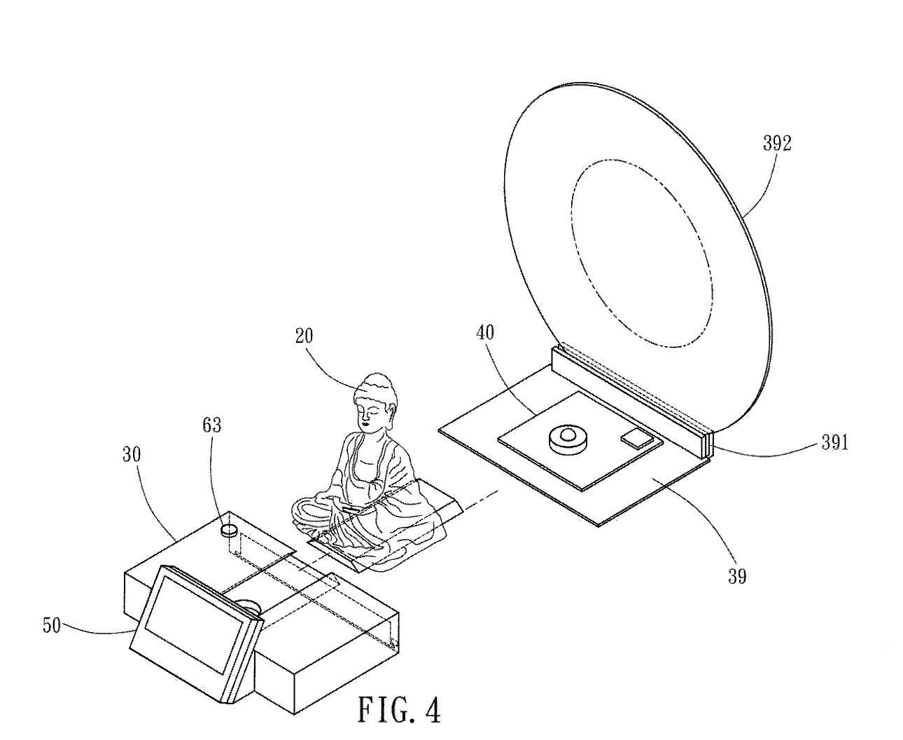

Referring to FIG. 3 and FIG. 4, the present invention provides another smart apparatus 10 which has the same essential structures and technical features as described above in the first preferred embodiment.

The multimedia module 63 is disposed on the top 302 of the base 30. The holder 39 has a slot 391. The user inserts a decorative item 392 into the slot 391 so as for the smart apparatus 10 to comfort the user, allowing the user to attain physical, mental and spiritual relaxation.

The essential structures and technical features of the first and second preferred embodiments of the present invention are described above. The intended advantages of the first and second preferred embodiments of the present invention are described below. Referring to FIG. 1 through FIG. 5, the prominent technical features and intended advantages of the smart apparatus 10 of the present invention are described below.

First, the smart apparatus 10 of the present invention is capable of effectuating wireless communication, transmission, and user interaction. The first wireless transmission module 41 of the control unit 40 of the smart apparatus 10 wirelessly receives an execution signal (not shown, for example, a signal pertaining to enquiry, editing, resetting, remote control, start, shutdown, or display) emitted from an external signal source (not shown, for example, a cell phone or an emitter) and sends the execution signal to the first microprocessor 43. Afterward, the first microprocessor 43 generates a display signal according to the execution signal and transmits, according to the display signal, a data or information, which is pre-stored in the memory module 45, to the display 53 of the display device 50 for display, so as to effectuate smart editing, transmission, and user interaction. Preferably, the first microprocessor 43 wirelessly transmits a confirmation signal (not shown, for example, a signal pertaining to transmission completion, transmission failure, transmission delay, or transmission compensation) to an external signal source through the first wireless transmission module 41 with a view to effectuating two-way interaction. The contents of information related to the data are obtained by selecting at least one or a plurality of information contents, namely text-related, symbol-related or graphic-related information constructed by a designer, then arranging, combining or designing the selected information contents in a specific manner, and finally editing the information contents.

Second, the smart apparatus 10 of the present invention is capable of providing a smart audiovisual signal source and exercising light source control. The first microprocessor 43 of the control unit 40 of the smart apparatus 10 generates a first power signal, a second power signal, or a multimedia signal according to the execution signal. The first microprocessor 43 sends the first power signal, the second power signal, or the multimedia signal to the power control module 47. The power control module 47 controls the display device 50 to brighten or darken according to the strength level of the first power signal. The power control module 47 controls the colored light emitting module 61 to brighten, darken or switch between multiple colors according to the strength level of the second power signal. The power control module 47 controls the multimedia module 63 to start or shut down according to the strength level of the multimedia signal. Not only does the power control module 47 of the control unit 40 control the multimedia module 63 to play or record, but the power control module 47 of the control unit 40 also controls the display device 50 and the colored light emitting module 61 to brighten, darken or switch between multiple colors in an eye-catching manner, allowing the smart apparatus 10 of the present invention to produce audio-video effects and exercise smart control thereof.

The technical features and intended advantages of the first and second preferred embodiments of the present invention are described above. The technical features of a smart apparatus operating system applicable to the first and second preferred embodiments are described below.

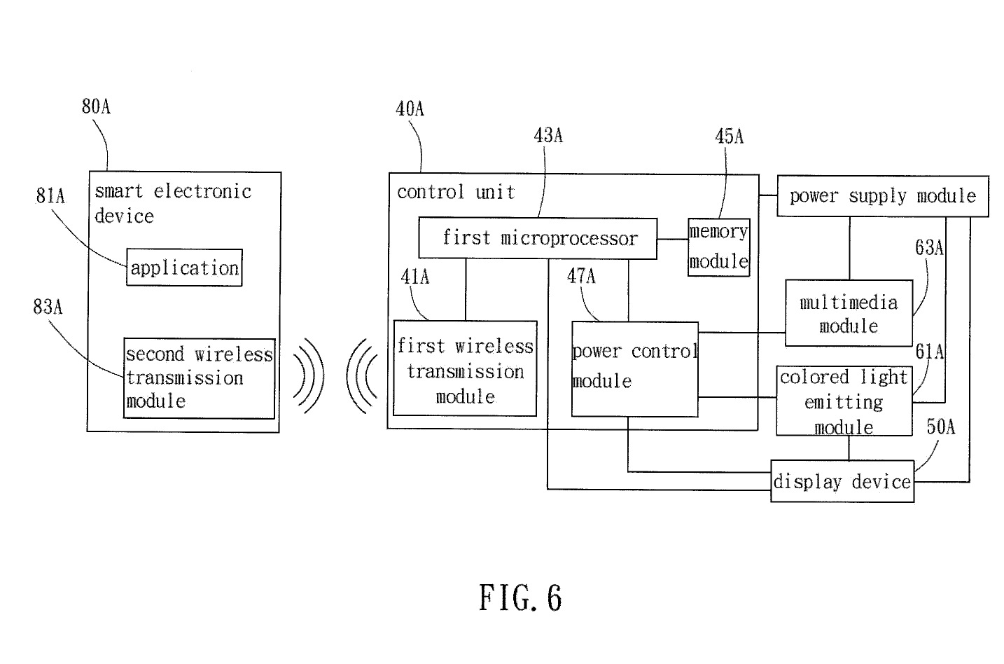

Referring to FIG. 6, the present invention provides a smart apparatus operating system which comprises a smart apparatus and a smart electronic device 80A.

The smart apparatus has the same essential technical features as described above in the first and second preferred embodiments. The smart electronic device 80A includes but is not constrainted to a cell phone, a tablet, or a notebook computer.

The smart electronic device 80A has an application 81A and a second wireless transmission module 83A. The application 81A is executable by the smart electronic device 80A. The second wireless transmission module 83A is controlled by the smart electronic device 80A. The second wireless transmission module 83A of the smart electronic device 80A is wirelessly, electrically connected to the first wireless transmission module 41A of the control unit 40A of the smart apparatus.

This embodiment has the same applicable advantages as described in the preceding embodiments and has a distinguishing technical feature as follows: the smart apparatus system is capable of effectuating long-distance control. Therefore, the application 81A is executed by the smart electronic device 80A to generate an execution signal. The second wireless transmission module 83A sends the execution signal to the first wireless transmission module 41A of the control unit 40A of the smart apparatus according to a communication protocol (such as Wi-Fi, NFC, ZigBee or Bluetooth communication transmission protocol) and then sends the execution signals to the first microprocessor 43A. Afterward, the first microprocessor 43A sends, according to the execution signal, a data pre-stored in the memory module 45A to the display module 50A for display. This embodiment is exemplified by the data provided in the form of at least one or a plurality of data. The second wireless transmission module 83A effectuates data transmission according to a wireless transmission communication protocol, such as Wi-Fi, wireless radio frequency communication transmission protocol (such as RF or sub-one GHz RF), ZigBee, Bluetooth communication transmission protocol (including but not constrainted to Bluetooth h2.x+EDR, Bluetooth h3.0+HS, Bluetooth 4.x, Bluetooth Low Energy), or NFC (near field communication). However, the aforesaid technical features are not restrictive of this embodiment of the present invention.

Likewise, the first microprocessor 43A of the control unit 40A of the smart apparatus generates a first power signal, a second power signal, or a multimedia signal according to the execution signal. The first microprocessor 43A sends the first power signal, the second power signal, or the multimedia signal to a power control module 47A. The power control module 47A controls the display device 50A to brighten or darken according to the strength level of the first power signal. The power control module 47A controls the colored light emitting module 61A to brighten, darken or switch between multiple colors according to the strength level of the second power signal. The power control module 47A controls the multimedia module 63A to start or shut down according to the strength level of the multimedia signal. Preferably, the first microprocessor 43A of the control unit 40A sends the confirmation signal wirelessly to the second wireless transmission module 83A of the smart electronic device 80A by the first wireless transmission module 41A so that the confirmation signal is presented to the user by the application 81A with a view to effectuating two-way interaction.

The technical features and advantages of a smart apparatus operating system of the first and second preferred embodiments are described above. The technical features of another smart apparatus operating system applicable to the first and second preferred embodiments are described below.

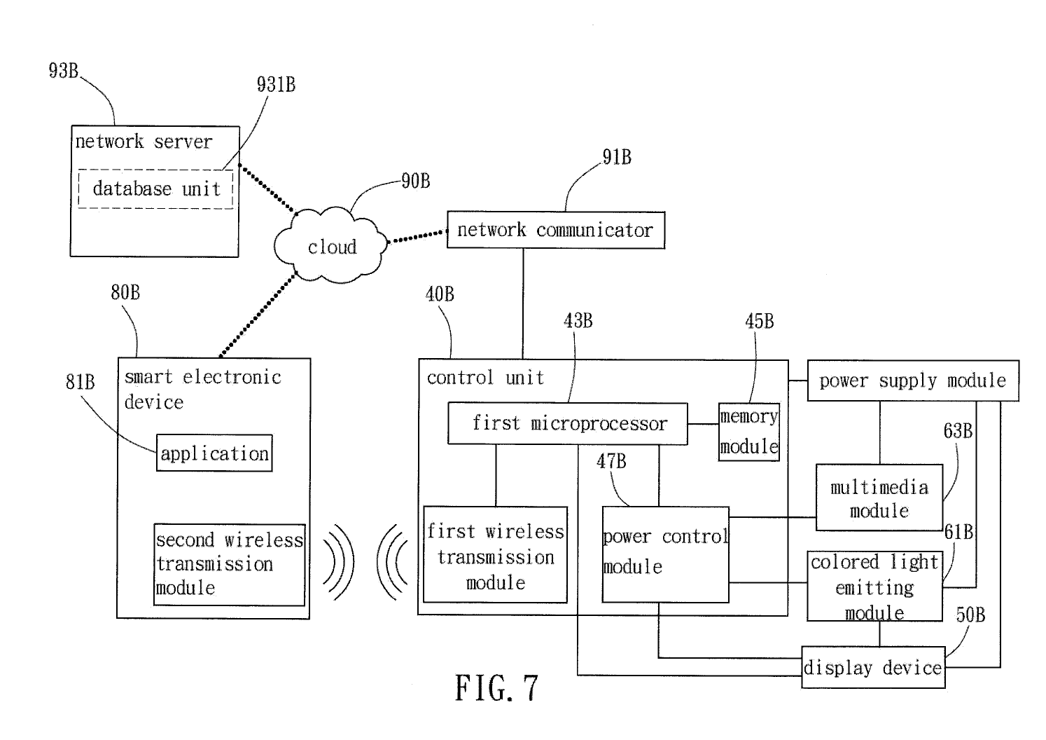

Referring to FIG. 7, the present invention provides another smart apparatus system which is distinguished from the preceding embodiments by technical features described below.

The smart apparatus system further comprises a network communicator 91B provided in the form of a router which supports wireless network communication protocols, such as Wi-Fi, 3G, 4G, and 5G. The network communicator 91B is electrically connected to the control unit 40B and connected to a cloud 90B through a network (such as wireless network communication protocols, for example, Wi-Fi, 3G, 4G, and 5G) so that the smart apparatus is connected to the cloud 90B through a network. In this embodiment, the cloud 90B includes but is not constrainted to functions, such as data computation, database processing, data analysis, or network transmission.

The smart apparatus system further comprises a network server 93B and is connected to the cloud 90B through a network (which supports wireless network communication protocols, for example, Wi-Fi, 3G, 4G, and 5G). The network server 93B has a database unit 931B for accessing and controlling a plurality of data. In this embodiment, the database unit 931B includes but is not constrainted to a network hard disk drive, a cloud hard disk drive, a network solid-state drive, or an array thereof.

The prominent technical features and intended advantages of this embodiment are described as follows: creating cloud data with the smart apparatus system and effectuating long-distance control. Therefore, the application 81B is executed by the smart electronic device 80B to generate an execution signal, and the execution signal is sent to the cloud 90B through the network. Afterward, the network communicator 91B receives the execution signal from the cloud 90B through the network and sends the execution signal to the control unit 40B of the smart apparatus. Afterward, the first microprocessor 43B of the control unit 40B generates a display signal according to the execution signal and sends, according to the display signal, a data pre-stored in the memory module 45B to the display device 50B for display. Afterward, the control unit 40B sends the data to the cloud 90B by the network communicator 91B through a network. The network server 93B receives the data through the cloud 90B and sends the data to a network storage position corresponding to the database unit 931B for storage. This embodiment is exemplified by the data provided in the form of at least one or a plurality of data. Preferably, the first microprocessor 43B of the control unit 40B sends the confirmation signal to the cloud 90B by the network communicator 91B through a network. The smart electronic device 80B receives the confirmation signal from the cloud 90B through a network so that the confirmation signal is presented to the user by the application 81B with a view to effectuating two-way interaction.

Likewise, the first microprocessor 43B of the control unit 40B of the smart apparatus generates a first power signal, a second power signal, or a multimedia signal according to the execution signal and sends the first power signal, the second power signal, or the multimedia signal to a power control module 47B. The power control module 47B controls the display device 50B to brighten or darken according to the strength level of the first power signal. The power control module 47B controls the colored light emitting module 61B to brighten, darken or switch between multiple colors according to the strength level of the second power signal. The power control module 47B controls the multimedia module 63B to start or shut down according to the strength level of the multimedia signal.

Persons skilled in the art fully understand that the above descriptions and embodiments of the present invention are illustrative of the structures, methods, process flows, and intended advantages of the present invention rather than restrictive of the claims of the present invention. Hence, replacements of and changes to the other equivalent elements, components, objects, structures, devices, methods, or process flows shall also be covered by the claims of the present invention.

What is claimed is:

1. A smart apparatus, comprising:
an action figure having an engaging portion;
a base having a receiving space and a constraint channel concavely formed on a surface of a top of the base so that the engaging portion of the action figure is engaged with and fixed to the constraint channel of the base;
a control unit disposed in the receiving space of the base and having a first wireless transmission module, a first microprocessor, a memory module, and a power control module, with the first microprocessor electrically connected to the first wireless transmission module, the memory module, and the power control module, respectively;
a display device mounted on the base and electrically connected to the first microprocessor and the power control module of the control unit, respectively;
a colored light emitting module disposed in the receiving space of the base and electrically connected to the power control module of the control unit; and
a power supply module disposed in the receiving space of the base and electrically respectively connected to the control unit, the display device, and the colored light emitting module to supply power to the control unit, the display device, and the colored light emitting module,
wherein the first wireless transmission module wirelessly receives an execution signal emitted from an external signal source and sends the execution signal to the first microprocessor, and the first microprocessor generates one of a first power signal, a second power signal, and/or a display signal according to the execution signal,
wherein the power control module controls the display device to brighten or darken according to a strength level of the first power signal and controls the colored light emitting module to brighten, darken or switch between multiple colors according to a strength level of the second power signal, whereas the first microprocessor sends, according to the display signal, a data pre-stored in the memory module to the display device for display and sends a confirmation signal to the external signal source wirelessly through the first wireless transmission module.

2. The smart apparatus in accordance with claim 1, further comprising a multimedia module disposed at the base and electrically connected to the power control module of the control unit, wherein the first microprocessor generates a multimedia signal according to the execution signal and sends the multimedia signal to the power control module, whereas the power control module controls the multimedia module to start or shut down according to a strength level of the multimedia signal.

3. The smart apparatus in accordance with claim 2, wherein the base further comprises a mounting portion disposed on an end surface of the base, and the display device is mounted on the mounting portion of the base.

4. The smart apparatus in accordance with claim 3, wherein the base further comprises a opening and a holder, the opening being in communication with the receiving space and corresponding in position to the mounting portion, the holder being engaged with and disposed in the receiving space through the opening so that the control unit, the colored light emitting module, the multimedia module, and the power supply module are placed on the holder.

5. The smart apparatus in accordance with claim 4, wherein the display device comprises a casing, a display, a dust-proof cover, and a top cover, the display being disposed in the casing, the dust-proof cover being a light penetrable component and covering the display, wherein an end of the top cover is pivotally connected to the casing so that, after being pivotally rotated, the top cover covers the casing, the display, and the dust-proof cover.

6. The smart apparatus in accordance with claim 2, wherein the base further comprises a opening and a holder, the opening being in communication with the receiving space and corresponding in position to the mounting portion, the holder being engaged with and disposed in the receiving space through the opening so that the control unit, the colored light emitting module, the multimedia module, and the power supply module are placed on the holder.

7. The smart apparatus in accordance with claim 6, wherein the display device comprises a casing, a display, a dust-proof cover, and a top cover, the display being disposed in the casing, the dust-proof cover being a light penetrable component and covering the display, wherein an end of the top cover is pivotally connected to the casing so that, after being pivotally rotated, the top cover covers the casing, the display, and the dust-proof cover.

8. The smart apparatus in accordance with claim 2, wherein the display device comprises a casing, a display, a dust-proof cover and a top cover, the display being disposed in the casing, the dust-proof cover being a light penetrable component and covering the display, wherein an end of the top cover is pivotally connected to the casing so that, after being pivotally rotated, the top cover covers the casing, the display, and the dust-proof cover.

9. A smart apparatus operating system, comprising:
the smart apparatus of claim 1 and a smart electronic device, the smart electronic device having an application and a second wireless transmission module, the application being executable by the smart electronic device, the second wireless transmission module being controlled by the smart electronic device, the second wireless transmission module of the smart electronic device is wirelessly, electrically connected to the first wireless transmission module of the control unit of the smart apparatus,
wherein the application is executed by the smart electronic device to generate the execution signal, and the second wireless transmission module sends the execution signal to the first wireless transmission module of the control unit of the smart apparatus and then to the first microprocessor according to a communication protocol, the first microprocessor generates one of the first power signal, the second power signal, and the display signal according to the execution signal, the first microprocessor wirelessly transmits the confirmation signal to the second wireless transmission module of the smart electronic device through the first wireless transmission module, and then the confirmation signal is displayed by the application.

10. The smart apparatus operating system in accordance with claim 9, further comprising a network communicator and a network server, with the network communicator being electrically connected to the control unit and connected to a cloud through a network, the smart apparatus being connected to the cloud through a network, and the network server being connected to the cloud through a network and having a database unit,
wherein the smart electronic device executes the application to generate the execution signal and sends the execution signal to the cloud through the network, the network communicator receives the execution signal from the cloud through the network and sends the execution signal to the control unit of the smart apparatus, the first microprocessor of the control unit generates one of the first power signal, the second power signal, and the display signal according to the execution signal,
wherein the control unit sends the data to the cloud with the network communicator through a network, the network server receives the data through the cloud and sends the data to a network storage position corresponding to the database unit for storage,
wherein the first microprocessor of the control unit sends the confirmation signal to the cloud with the network communicator through a network, the smart electronic device receives the confirmation signal from the cloud through a network, and the confirmation signal is displayed by the application.

11. A smart apparatus operating system, comprising:
the smart apparatus of claim 2 and a smart electronic device, the smart electronic device having an application and a second wireless transmission module, the application being executable by the smart electronic device, the second wireless transmission module being controlled by the smart electronic device, the second wireless transmission module of the smart electronic device is wirelessly, electrically connected to the first wireless transmission module of the control unit of the smart apparatus,
wherein the application is executed by the smart electronic device to generate the execution signal, and the second wireless transmission module sends the execution signal to the first wireless transmission module of the control unit of the smart apparatus and then to the first microprocessor according to a communication protocol, the first microprocessor generates one of the first power signal, the second power signal, and the display signal according to the execution signal, the first microprocessor wirelessly transmits the confirmation signal to the second wireless transmission module of the smart electronic device through the first wireless transmission module, and then the confirmation signal is displayed by the application.

12. The smart apparatus operating system in accordance with claim 11, further comprising a network communicator and a network server, with the network communicator being electrically connected to the control unit and connected to a cloud through a network, the smart apparatus being connected to the cloud through a network, and the network server being connected to the cloud through a network and having a database unit,
wherein the smart electronic device executes the application to generate the execution signal and sends the execution signal to the cloud through the network, the network communicator receives the execution signal from the cloud through the network and sends the execution signal to the control unit of the smart apparatus, the first microprocessor of the control unit generates one of the first power signal, the second power signal, and the display signal according to the execution signal,
wherein the control unit sends the data to the cloud with the network communicator through a network, the network server receives the data through the cloud and sends the data to a network storage position corresponding to the database unit for storage,
wherein the first microprocessor of the control unit sends the confirmation signal to the cloud with the network communicator through a network, the smart electronic device receives the confirmation signal from the cloud through a network, and the confirmation signal is displayed by the application.

13. A smart apparatus operating system, comprising:
the smart apparatus of claim 3 and a smart electronic device, the smart electronic device having an application and a second wireless transmission module, the application being executable by the smart electronic device, the second wireless transmission module being controlled by the smart electronic device, the second wireless transmission module of the smart electronic device is wirelessly, electrically connected to the first wireless transmission module of the control unit of the smart apparatus,
wherein the application is executed by the smart electronic device to generate the execution signal, and the second wireless transmission module sends the execution signal to the first wireless transmission module of the control unit of the smart apparatus and then to the first microprocessor according to a communication protocol, the first microprocessor generates one of the first power signal, the second power signal, and the display signal according to the execution signal, the first microprocessor wirelessly transmits the confirmation signal to the second wireless transmission module of the smart electronic device through the first wireless transmission module, and then the confirmation signal is displayed by the application.

14. The smart apparatus operating system in accordance with claim 13, further comprising a network communicator and a network server, with the network communicator being electrically connected to the control unit and connected to a cloud through a network, the smart apparatus being connected to the cloud through a network, and the network server being connected to the cloud through a network and having a database unit,
wherein the smart electronic device executes the application to generate the execution signal and sends the execution signal to the cloud through the network, the network communicator receives the execution signal from the cloud through the network and sends the execution signal to the control unit of the smart apparatus, the first microprocessor of the control unit generates one of the first power signal, the second power signal, and the display signal according to the execution signal,
wherein the control unit sends the data to the cloud with the network communicator through a network, the network server receives the data through the cloud and sends the data to a network storage position corresponding to the database unit for storage,
wherein the first microprocessor of the control unit sends the confirmation signal to the cloud with the network communicator through a network, the smart electronic device receives the confirmation signal from the cloud through a network, and the confirmation signal is displayed by the application.

15. A smart apparatus operating system, comprising:
the smart apparatus of claim 4 and a smart electronic device, the smart electronic device having an application and a second wireless transmission module, the application being executable by the smart electronic device, the second wireless transmission module being controlled by the smart electronic device, the second wireless transmission module of the smart electronic device is wirelessly, electrically connected to the first wireless transmission module of the control unit of the smart apparatus,
wherein the application is executed by the smart electronic device to generate the execution signal, and the second wireless transmission module sends the execution signal to the first wireless transmission module of the control unit of the smart apparatus and then to the first microprocessor according to a communication protocol, the first microprocessor generates one of the first power signal, the second power signal, and the display signal according to the execution signal, the first microprocessor wirelessly transmits the confirmation signal to the second wireless transmission module of the smart electronic device through the first wireless transmission module, and then the confirmation signal is displayed by the application.

16. The smart apparatus operating system in accordance with claim 15, further comprising a network communicator and a network server, with the network communicator being electrically connected to the control unit and connected to a cloud through a network, the smart apparatus being connected to the cloud through a network, and the network server being connected to the cloud through a network and having a database unit,
wherein the smart electronic device executes the application to generate the execution signal and sends the execution signal to the cloud through the network, the network communicator receives the execution signal from the cloud through the network and sends the execution signal to the control unit of the smart apparatus, the first microprocessor of the control unit generates one of the first power signal, the second power signal, and the display signal according to the execution signal,
wherein the control unit sends the data to the cloud with the network communicator through a network, the network server receives the data through the cloud and sends the data to a network storage position corresponding to the database unit for storage,
wherein the first microprocessor of the control unit sends the confirmation signal to the cloud with the network communicator through a network, the smart electronic device receives the confirmation signal from the cloud through a network, and the confirmation signal is displayed by the application.

17. A smart apparatus operating system, comprising:
the smart apparatus of claim 5 and a smart electronic device, the smart electronic device having an application and a second wireless transmission module, the application being executable by the smart electronic device, the second wireless transmission module being controlled by the smart electronic device, the second wireless transmission module of the smart electronic device is wirelessly, electrically connected to the first wireless transmission module of the control unit of the smart apparatus,
wherein the application is executed by the smart electronic device to generate the execution signal, and the second wireless transmission module sends the execution signal to the first wireless transmission module of the control unit of the smart apparatus and then to the first microprocessor according to a communication protocol, the first microprocessor generates one of the first power signal, the second power signal, and the display signal according to the execution signal, the first microprocessor wirelessly transmits the confirmation signal to the second wireless transmission module of the smart electronic device through the first wireless transmission module, and then the confirmation signal is displayed by the application.

18. The smart apparatus operating system in accordance with claim 17, further comprising a network communicator and a network server, with the network communicator being electrically connected to the control unit and connected to a cloud through a network, the smart apparatus being connected to the cloud through a network, and the network server being connected to the cloud through a network and having a database unit,
wherein the smart electronic device executes the application to generate the execution signal and sends the execution signal to the cloud through the network, the network communicator receives the execution signal from the cloud through the network and sends the execution signal to the control unit of the smart apparatus, the first microprocessor of the control unit generates one of the first power signal, the second power signal, and the display signal according to the execution signal,
wherein the control unit sends the data to the cloud with the network communicator through a network, the network server receives the data through the cloud and sends the data to a network storage position corresponding to the database unit for storage,
wherein the first microprocessor of the control unit sends the confirmation signal to the cloud with the network communicator through a network, the smart electronic device receives the confirmation signal from the cloud through a network, and the confirmation signal is displayed by the application.

19. A smart apparatus operating system, comprising:
the smart apparatus of claim 6 and a smart electronic device, the smart electronic device having an application and a second wireless transmission module, the application being executable by the smart electronic device, the second wireless transmission module being controlled by the smart electronic device, the second wireless transmission module of the smart electronic device is wirelessly, electrically connected to the first wireless transmission module of the control unit of the smart apparatus,
wherein the application is executed by the smart electronic device to generate the execution signal, and the second wireless transmission module sends the execution signal to the first wireless transmission module of the control unit of the smart apparatus and then to the first microprocessor according to a communication protocol, the first microprocessor generates one of the first power signal, the second power signal, and the display signal according to the execution signal, the first microprocessor wirelessly transmits the confirmation signal to the second wireless transmission module of the smart electronic device through the first wireless transmission module, and then the confirmation signal is displayed by the application.

20. The smart apparatus operating system in accordance with claim 19, further comprising a network communicator and a network server, with the network communicator being electrically connected to the control unit and connected to a cloud through a network, the smart apparatus being connected to the cloud through a network, and the network server being connected to the cloud through a network and having a database unit,
wherein the smart electronic device executes the application to generate the execution signal and sends the execution signal to the cloud through the network, the network communicator receives the execution signal from the cloud through the network and sends the execution signal to the control unit of the smart apparatus, the first microprocessor of the control unit generates one of the first power signal, the second power signal, and the display signal according to the execution signal,
wherein the control unit sends the data to the cloud with the network communicator through a network, the network server receives the data through the cloud and sends the data to a network storage position corresponding to the database unit for storage,
wherein the first microprocessor of the control unit sends the confirmation signal to the cloud with the network communicator through a network, the smart electronic device receives the confirmation signal from the cloud through a network, and the confirmation signal is displayed by the application.
